(19) United States
(12) Patent Application Publication
(10) Pub. No.: US 2008/0297066 A1
(43) Pub. Date: Dec. 4, 2008

(54) Illumination Device and Method for Controlling an Illumination Device

(75) Inventors: Eduard Johannes Meijer, Eindhoven (NL); Christoph Martiny, Aachen (DE); Volkmar Schulz, Stolberg (DE); Matthias Wendt, Wuerselen (DE); Per Ambrosiussen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/097,292

(22) PCT Filed: Dec. 7, 2006
(86) PCT No.: PCT/IB06/54656

§ 371 Date: Jun. 13, 2008

(30) Foreign Application Priority Data
Dec. 16, 2005 (EP) 05112341.2

(51) Int. Cl. H05B 33/02

(52) U.S. Cl. 315/291

(57) ABSTRACT

The present invention relates to a method for controlling an illumination device (100), the illumination device (100) comprising a flux sensing unit (101) and at least two differently colored light sources (102, 103, 104), the method comprising the steps of switching on and off each of the light sources according to a predefined pattern, acquiring measurement values by means of the flux sensing unit at predetermined intervals in accordance with the predefined pattern, calculating a color point for each of the light sources based on the measurement values, calculating a difference between the color points and corresponding reference color points, and adjusting an analog current drive level of the light sources, wherein the difference is minimized such that a desired color is obtained. The present invention provides for the possibilities to in a more accurate way correct for the color changes due to change in drive current, temperature, and aging effects. Furthermore, the control method according to the present invention does not require a factory calibration, or knowledge of batch specific binning information, for obtaining the current or temperature related characteristics of the light sources, which significantly reduces the cost normally related to factory calibration and batch specific binning information. Furthermore, the present invention relates to an illumination device (100) comprising means for performing such a method.

The present invention relates to a method for controlling an illumination device. The present invention also relates to an illumination device comprising means for performing such a method.

Recently, much progress has been made in increasing the brightness of light emitting diodes (LEDs). As a result, LEDs have become sufficiently bright and inexpensive to serve as a light source in for example lighting system such as lamps with adjustable color, direct view Liquid Crystal Displays (LCDs), and in front and rear projection displays.

By mixing differently colored LEDs any number of colors can be generated, e.g. white. An adjustable color lighting system is typically constructed by using a number of primary colors, and in one example, the three primaries red, green and blue are used. The color of the generated light is determined by which of the LEDs that are used, as well as by the mixing ratios. To generate “white”, all three LEDs have to be turned on.

The control of LEDs typically involves pulse width modulation (PWM), which regulates the brightness and thereby the mixing ration of the LEDs. By controlling the time an LED is turned on and off, and doing so fast enough, the LED will appear to stay on continuously. Since there is less current flowing overall, the LED will appear less bright. However, controlling LEDs using pulse width modulation involves expensive PWM drivers. Furthermore, PWM is cumbersome in implementation of the drivers, which then need to meet the requirements of switching on and off without considerable overshoot since the overshoots will generate current spiking in the system, thereby shortening the lifetime of the LEDs and moreover affect the accuracy of the color control.

U.S. Pat. No. 6,507,159 discloses an alternative solution to PWM, by using analog forward current for controlling an RGB (Red, Green, Blue) based luminary arranged to produce mixed light. By adjusting the amplitude of the current supplied to the LEDs, it is possible to control the brightness of the LEDs. Obviously the driving scheme will result in color changes as the LEDs are driven at different current densities. This issue is tackled by measuring the color point of the mixed light, and adjusting it to the desired color. However, as the mixed color is measured, there is a need for complex deconvolution circuitry to obtain the individual color points of the differently colored LEDs.

It is therefore an object of the present invention to provide an improved method for controlling an illumination device, which substantially overcomes the disadvantages of the prior art while providing further improvements in terms of cost and manufacturing convenience.

The above object is met by a method for controlling an illumination device as defined in claim 1 below, and an illumination device comprising means for performing such a method as defined in claim 7. The appended sub-claims define advantageous embodiments in accordance with the present invention.

According to an aspect of the invention, there is provided a method for controlling an illumination device, said illumination device comprising a flux sensing unit and at least two differently colored light sources, said method comprising the steps of switching on and off each of said light sources according to a predefined pattern, acquiring measurement values by means of said flux sensing unit at predetermined intervals in accordance with said predefined pattern, calculating a color point for each of said light sources based on said measurement values, calculating a difference between said color points and corresponding reference color points, and adjusting an analog current drive level of said light sources, wherein said difference is minimized such that a desired color is obtained. For the minimization of the difference, for instance a proportional integral-derivative (PID) controller might be used.

The expression “switching on and off according to a predefined pattern” is understood to mean that the light sources will be turned on and off in such a way that it will be possible to perform simple deconvolution of the measurement values such that individual color points for the differently colored light sources can be calculated.

This aspect of the present invention provides for the possibilities to in a more accurate way correct for the color changes due to change in drive current, temperature, and aging effects. As the light sources are controlled using an analog current drive level, by modifying the amplitude of the current rather than PWM control, the switching requirements will be much less stringent, hence a control driver can be less complex, resulting in a less expensive illumination device. The method according to the present invention is primarily used during a measurement cycle that generally occurs at the startup and change of a desired color of the illumination device. However, a measurement cycle may of course occur during regular use of the illumination device, but will in this case preferably be fast as the light sources will be turned on and off shortly during the measurement cycle. Furthermore, the control method according to the present invention does not require a factory calibration of the light sources, or knowledge of batch specific binning information, for obtaining the current or temperature related characteristics of the light sources, which significantly reduces the cost normally related to factory calibration and batch specific binning information.

Preferably, the predefined switching pattern is a sequentially switching pattern. This means that only one of the light sources will be turned on at a time during the acquisition of a measurement. As in this case, no deconvolution is needed to obtain the measurement values, the requirement on a controller unit performing these actions could therefore be eased. Furthermore, as even narrow banded light sources, such as LEDs, generally have a wavelength tail, obtaining individual measurements for each of the differently colored light sources without the interference from other colored light sources will provide for improved measurement results. As part of the sequentially switching pattern, all light sources could be turned off, providing for measurement of ambient light originating from outside the illumination device.

In one preferred embodiment of the present invention, the flux-sensing unit comprises at least one flux sensor, such as at least one photodiode, having filters adapted to selectively allow for transmission of light emitted by said light sources. When a filtered flux sensor is used, where the filter is permeable to light within more than one wavelength range, it is possible to reduce the number of sensors required to perform the above-described measurements. This will provide for improvements in terms of cost and manufacturing convenience as such a sensor will provide for more freedom in placement of the flux-sensing unit comprised in the illumination device. For example, in one implementation the illumination device is an adjustable color variable illumination device, comprising three narrow banded differently colored light sources, such as light emitting diodes (LEDs) of the colors red, green and blue, and the flux sensing unit comprises a single filtered flux sensor adapted to selectively allow for transmission of red, green and blue light. Further, in a system comprising four differently colored light sources, two flux sensors coated with “multi-peak filters”, where each of the filters coated on the flux sensors are permeable to light emitted by two of the four light sources, can be used. Furthermore, it would be possible to include an unfiltered flux sensor in the flux-sensing unit. It would be possible to use this unfiltered flux sensor in conjunction with the at least one filtered flux sensor to achieve a higher measurement accuracy.

Preferably, the flux sensor is coated with a Fabry-Perot interference filter. The transmission of a Fabry-Perot interference filter depends primarily on the thickness of the dielectric layer and the angle the incident light. If the thickness of the dielectric layer is chosen carefully, in combination with the refractive index, it is possible to have multiple transmission peaks in the visible spectrum. The person skilled in the art understands that other types of interference filters can be used to achieve the same result as described above.

In an alternative embodiment of the present invention, the flux-sensing unit comprises one filtered flux sensor for each of said differently colored light sources. In some implementations, this might be a preferred solution. However, as no complex deconvolution is needed to obtain the measurement values, the requirement on the controller unit performing these actions could, as mentioned above, therefore be eased. For example, in one implementation where the illumination device comprises three differently colored light sources (red, green, blue), the flux sensing unit would comprise one flux sensor for detecting “red light”, one flux sensor for detecting “green light” and one flux sensor for detecting “blue light”. It would of course be possible to use more than one flux sensor for each of said differently colored light sources.

In another preferred embodiment, the differences between the color points and corresponding reference color points are compared to a predetermined threshold level, and the method steps mentioned above are repeated until the difference is below the threshold level. As the present invention is performed iteratively, it is possible to let the light sources stabilize at the desired color points, for example selected by a user. It would be advantageous to minimize the difference in such a way that the difference approaches zero, but it would of course be possible to limit the number of iterations to a pre-selected maximum.

According to another aspect of the present invention there is provided an illumination device, said illumination device comprising a flux sensing unit, at least two differently colored light sources, means for switching on and off each of said light sources according to a predefined pattern, means for acquiring measurement values from said flux sensing unit at predetermined intervals in accordance with said predefined pattern, means for calculating a color point for each of said light sources based on said measurement values, means for calculating a difference between said color points and corresponding reference color points, and means for adjusting an analog current drive level of said light sources, wherein said difference is minimized such that a desired color is obtained. By means of this aspect of the present invention it is, in a similar and analogue way as described above with reference to the first aspect of the invention, possible to in a more accurate way correct for the color changes due to change in drive current, temperature, and aging effects.

Preferably, a user interface is connected to the illumination device. This provides for allowing a user to adjust the color of the light emitted by the illumination device such that a new desired color is emitted. When adjusting the illumination device, a new measurement cycle is preferably performed such that the correct color is emitted.

The invention is advantageously used as a component in for example, but not limited to, a backlighting system. Furthermore, the illumination device according to the present invention can be used together with a display in a display device.

Further features of, and advantages with, the present invention will become apparent when studying the appended claims and the following description. Those skilled in the art realize that different features of the present invention can be combined to create embodiments other than those described in the following.

These and other aspects of the present invention will now be described in more detail, with reference to the appended drawings showing currently preferred embodiments of the invention, in which

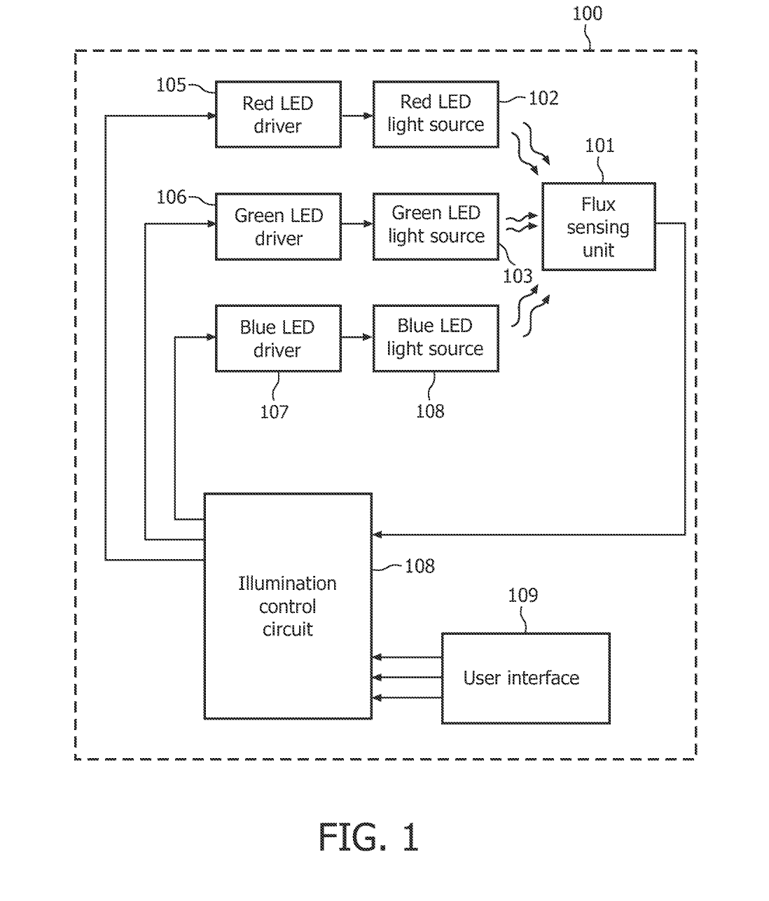

FIG. 1 is a block diagram showing an illumination device according to a currently preferred embodiment of the present invention;

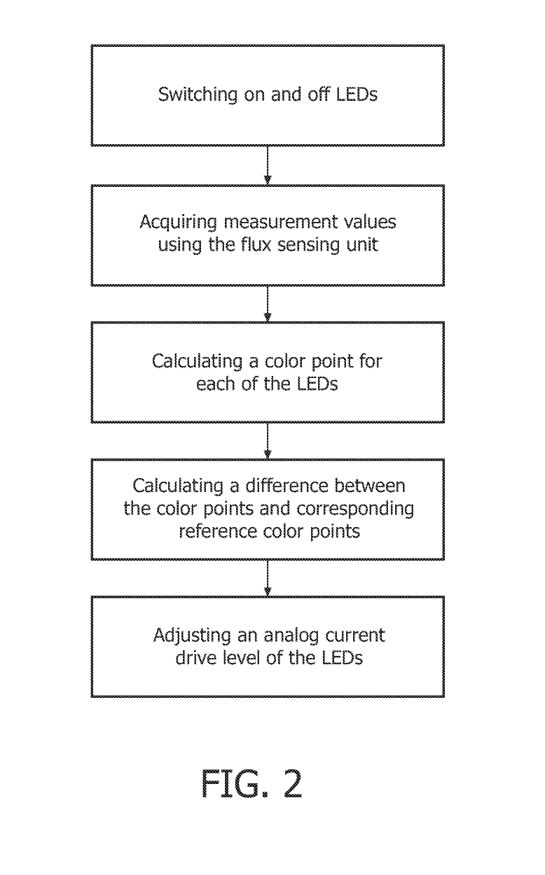

FIG. 2 is a flow chart showing the steps of a method according to an embodiment of the present invention;

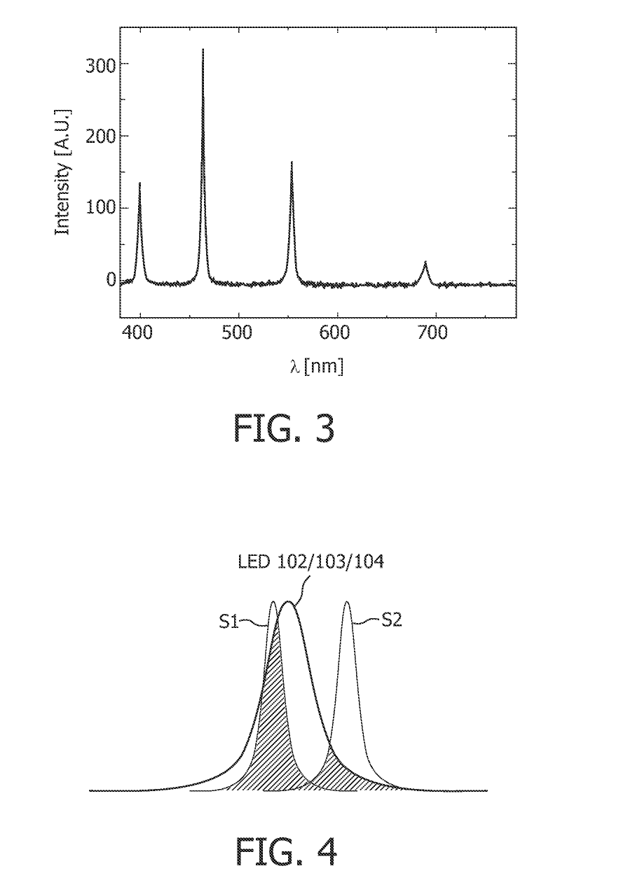

FIG. 3 is a graph showing the spectral response of a filtered flux sensor having multiple transmission peaks in the visible spectrum; and

FIG. 4 illustrates the measurement of the peak value of one of the LEDs using two filtered flux sensors.

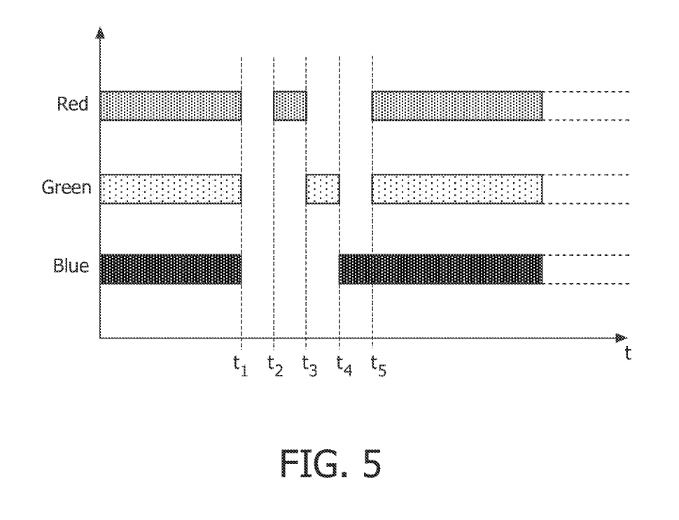

FIG. 5 illustrates a measurement cycle where the illumination device comprises three light sources.

FIG. 1 is a block diagram of an adjustable color illumination device 100 arranged in accordance with a currently preferred embodiment of the present invention. In the exemplary embodiment, the illumination device 100 comprises three LED light sources of the colors red 102, green 103 and blue 104, each connected to a corresponding driver circuit 105, 106 and 107. As understood by the person skilled in the art, it is of course possible to use more that three differently colored light sources. Furthermore, it would be possible to use either single light sources or a string of light sources of the same color.

When the lighting device 100 is powered up, an illumination control circuit 108 will acquire a desired color to be emitted by the illumination device 100 from a user interface 109, connected to the illumination control circuit 108 either by a wired or a wireless connection. The user interface 109 may include user input devices, such as buttons and adjustable controls, that produce a signal or voltage to be read by the illumination control circuit 108. The voltage may be a digital signal corresponding to a high and a low digital state. If the voltage is in the form of an analog voltage, an analog to digital converter (A/D) may be used to convert the voltage into a useable digital form. The output from the A/D would then supply the illumination control circuit 108 with a digital signal. The illumination control circuit 108 may include a microprocessor, micro controller, programmable digital signal processor or another programmable device. The illumination control circuit 108 may also, or instead, include an application specific integrated circuit, a programmable gate array programmable array logic, a programmable logic device, or a digital signal processor. Where the illumination control circuit 108 includes a programmable device such as the microprocessor or micro controller mentioned above, the processor may further include computer executable code that controls operation of the programmable device.

The illumination control circuit 108 will calculate the color gamut and corresponding color points (i.e. white point), using techniques well known in the art, for the desired color, and provide drive signals corresponding to the calculated color points to each of the LED drivers 105-107, which in turn will provide the LEDs 102-104 with an analog drive current. At the same time, a flux-sensing unit 101, arranged such that light from all three LEDs will impinge on the flux-sensing unit 101, is activated.

The illumination control circuit 108 will start switching on and off each of the LEDs according to a predefined pattern, as for example the sequential pattern as shown in FIG. 4, which will be explained in more detail below. Correspondingly, the flux-sensing unit 101 will measure the light emitted by the LEDs at predetermined intervals in accordance with the above-mentioned predefined pattern. The analog flux signal is translated to a corresponding digital signal using an A/D converter (not shown) and provided back to the illumination control circuit 108 in a feedback manner.

The digital feedback signal is converted to a corresponding color point for each of the LEDs and compared to the earlier calculated color points. If the difference is greater than a predetermined threshold, the drive signals provided to the LED drivers 105-107 are adjusted accordingly. Furthermore, for the minimization of the difference, for instance a proportional integral-derivative (PID) controller might be used. As understood by the person skilled in the art, in the case that the flux-sensing unit is a passive component, it might be activated at all time, and the illumination control circuit 108 will “sample” the flux sensing unit 101 at predetermined time intervals as described above.

The illumination device 100 may furthermore be configured to perform the method steps (i.e. switching, acquiring, calculating, comparing and adjusting as described above) in an iterative manner such that the difference between the measured color points and the desired color points are minimized below the threshold. It would also be possible to maximize the number of iterations to a suitable number depending on the type of adjustment approach used when adjusting the drive signals.

The method according to the present invention is repeated at suitable time intervals (for example once an hour) to compensate for change in ambient temperature and aging. Furthermore, as the user interface 109 is adjusted, the method steps are repeated accordingly. The method according to the present invention performed by the illumination device 100 as described above is summarized in FIG. 2.

In the exemplary embodiment, the flux-sensing unit 101 comprises at least two flux sensors, S1 and S2, having filters adapted to selectively allow for transmission of light emitted by the LEDs 102-104 and at least one unfiltered flux sensor. The spectral response for such a filter can be seen in FIG. 3. The response of the second filter is shifted slightly with respect to the first filter. It is possible to combine the results from the at least two filtered flux sensors S1 and S2 with slightly shifted filters, and calculate the peak wavelength of each of the LEDs 102-104. With prior knowledge of the first and the second sensors S1 and S2 slightly shifted peak wavelengths, this is achieved by calculating a ratio between the measurement results from the first and the second sensor, and comparing this ratio with the sensors peak wavelengths. An illustration of this can be seen in FIG. 4 for one of the LEDs 102-104. The unfiltered flux sensor is used to measure the ambient lighting.

Preferably, Fabry-Perot interference filter are used. The transmission of a Fabry-Perot interference filter depends primarily on the thickness of the dielectric layer and the angle the incident light makes with the surface normal of the filter through:

kλ=2nd cos Θ (1)

where k is an integer denoting the order of the resonance, λ is the peak wavelength of the transmitted light, n is the refractive index of the dielectric layer, d is the thickness of the dielectric layer, and Θ is the angle between the incident light beam and the surface normal of the Fabry-Perot etalon. If the thickness of the dielectric layer is chosen thin enough, there will only be one transmission peak in the visible spectrum (380-780 nm) for k=1. However, if the dielectric layer thickness (in combination with the refractive index) is chosen thicker, it is possible to have multiple transmission peaks in the visible spectrum, as is given by FIG. 3. This means that if the flux sensor of the flux sensing unit 101 is coated with such a filter, it can function as both a filter in the red region (around 700 nm in FIG. 3), in the green region (around 550 nm) and in the blue region (around 400 and 460 nm).

By using a flux sensing unit 101 as described above in combination with the method according to the present invention where the LEDs 102-104 are switched on and off according to a predetermined switching pattern, it is possible to reduce the number of sensors, and thereby the number of sensor channels. Alternatively, it would be possible to combine a plurality of standard filtered flux sensors, where the filters of each of the flux sensors are tuned to be permeable to light emitted by each of the differently colored LEDs. For example, as in the exemplary embodiment, where the illumination device 100 comprises three differently colored light sources (red LED 102, green LED 103, blue LED 104), the flux sensing unit 101 would comprise one flux sensor for detecting “red light”, one flux sensor for detecting “green light” and one flux sensor for detecting “blue light”.

Turning now to FIG. 5, wherein an example of a predetermined switching pattern is shown. The switching pattern as shown in FIG. 5 is a sequential switching pattern, where initially at t₁ all the LEDs 102-104 are turned off. Some time between t₁ and t₂ the illumination control circuit 108 will sample the flux sensing unit 101, thereby obtaining flux information relating to the ambient lighting. This ambient flux information may if desired be used to adjust the succeeding measurements for ambient lighting. As understood by the skilled addressee, it would be possible to perform multiple sampling of each of the measurements to achieve a higher accuracy. At t₂, the red LED 102 is turned on and illumination control circuit 108 will sample the flux-sensing unit 101. Subsequently at t₃, the red LED 102 is turned off, and the green LED 103 is turned on. The illumination control circuit 108 once again sample the flux-sensing unit 101 to acquire a measurement for the green LED 103. The same measurement step is repeated for the blue LED 104. After that, as described above with reference to FIG. 1, the illumination control circuit 108 will calculate a color point for each of the LEDs, compare them to desired color points and adjust the analog drive signals to each of the LEDs such that the desired color is obtained.

It is understood that it would be possible to use any other type of predetermined switching pattern. For example, it would be possible to use an inverted type of switching pattern, as compared to the switching pattern shown in FIG. 5, where instead of turning off all of the LEDs 101-104, only one of the LEDs will be turned off at a time. By means of a system of equations it will then be possible to calculate the individual color points for each of the differently colored LEDs. However, this will require a more complex deconvolution process, in turn requiring an illumination control circuit 108, adapted to perform more complex signal processing. In relation to cost this might not be desirable, but it would be possible to let design and implementation approach determine what type of predetermined switching pattern that should be used.

The person skilled in the art realizes that the present invention by no means is limited to the preferred embodiments described above. On the contrary, many modifications and variations are possible within the scope of the appended claims. For example, it is possible to use a temperature sensor to compensate for variations in the spectral response of the flux sensors that relates to ambient temperature variations. Furthermore, the present invention is advantageously used with other types of light sources, such as OLEDs, PLEDs, an organic LEDs, lasers, CCFL, HCFL, plasma lamps or a combination thereof.

1. A method for controlling an illumination device (100), said illumination device (100) comprising a flux sensing unit (101) and at least two differently colored light sources (102, 103, 104), said method comprising the steps of:
switching on and off each of said light sources (102, 103, 104) according to a predefined pattern;
acquiring measurement values by means of said flux sensing unit (101) at predetermined intervals in accordance with said predefined pattern;
calculating a color point for each of said light sources (102, 103, 104) based on said measurement values;
calculating a difference between said color points and corresponding reference color points; and
adjusting an analog current drive level of said light sources, wherein said difference is minimized such that a desired color is obtained.

2. A method according to claim 1, wherein said predefined switching pattern is a sequentially switching pattern.

3. A method according to claim 1, wherein said flux sensing unit (101) comprises at least one flux sensor having filters adapted to selectively allow for transmission of light emitted by said light sources.

4. A method according to claim 3, wherein said at least one flux sensor is coated with a Fabry-Perot interference filter.

5. A method according to claim 1, wherein said flux sensing unit (101) comprises one filtered flux sensor for each of said differently colored light sources.

6. A method according to claim 1, said method further comprising the steps of:
comparing said difference with a predetermined threshold level; and
repeating the steps recited in claim 1 until said difference is below said threshold level.

7. An illumination device (100), said illumination device comprising:
a flux sensing unit (101);
at least two differently colored light sources (102, 103, 104);
means for switching on and off each of said light sources according to a predefined pattern (108);
means for acquiring measurement values (108) from said flux sensing unit (101) at predetermined intervals in accordance with said predefined pattern;
means for calculating a color point (108) for each of said light sources (102, 103, 104) based on said measurement values;
means for calculating a difference between said color points and corresponding reference color points (108); and
means for adjusting an analog current drive level (108) of said light sources (102, 103, 104), wherein said difference is minimized such that a desired color is obtained.

8. An illumination device (100) according to claim 7, wherein said illumination device (100) further comprises a user interface (109) for allowing a user to select said desired color.

9. An illumination device (100) according to claim 7 wherein said predefined switching pattern is a sequentially switching pattern.

10. An illumination device (100) according to claim 7, wherein said flux sensing unit (101) comprises at least one flux sensor having filters adapted to selectively allow for transmission of light emitted by said light sources.

11. An illumination device according to claim 10, wherein said at least one flux sensor is coated with a Fabry-Perot interference filter.

12. A backlighting system comprising an illumination device (100) according to claim 7.

13. A display device comprising a display and an illumination device (100) according to claim 7.
